(19) United States
(12) Patent Application Publication
(10) Pub. No.: US 2024/0411855 A1
(43) Pub. Date: Dec. 12, 2024

(54) UNIQUE IDENTIFIER ASSIGNATION

(71) Applicant: JAMF Software, LLC, Minneapolis, MN (US)

(72) Inventors: Eric Blakely, Wilton, NY (US); Aaron Maxim, Bainbridge Island, WA (US); Jonathan Fretheim, Eau Claire, WI (US); Jonathan Yuresko, Doylestown, PA (US)

(21) Appl. No.: 18/735,544

(22) Filed: Jun. 6, 2024

Related U.S. Application Data
(60) Provisional application No. 63/506,415, filed on Jun. 6, 2023.

(51) Int. Cl. G06F 21/45

(52) U.S. Cl. CPC G06F 21/45

(57) ABSTRACT

In certain aspects, a computer-implemented method includes displaying a selection of groups of members associated with a manager device; retrieving, responsive to selection of one group of the groups of members associated with manager device, group objects associated with the one group that is selected; determining whether the members of the group selected are selected to be unassigned; displaying, responsive to determining that the members of the group selected are to remain assigned, a list of members of the group selected; receiving a selection of one member of the list of the group selected; determining whether the one member selected is assigned; creating, responsive to determining that the one member selected is unassigned, a unique identifier associated the group objects and the one member selected; displaying the unique identifier; and assigning, responsive to a managed device scanning the unique identifier and based on confirmation to assign, the one member selected to the managed device.

### CROSS-REFERENCE TO RELATED APPLICATION

The present application claims the benefit of priority under 35 U.S.C. § 119 from U.S. Provisional Patent Application Ser. No. 63/506,415 entitled “Unique Identifier Generation,” filed on Jun. 6, 2023, the disclosure of which is hereby incorporated by reference in its entirety for all purposes.

### TECHNICAL FIELD

The present disclosure generally relates to unique identifiers, and more specifically relates to assigning unique identifiers.

### BACKGROUND

It takes time to create unique identifiers, such as QR codes and bar codes, that could be used for various assignment or allocation purposes in an organizational setting. Generating these unique identifiers ahead of time leaves room for net new devices at time of need, or users, to not be granted said unique identifier so on the fly automatic updating is required in order to be up to date with user roster or devices. As an example, IT makes a student roster of bar codes at the beginning of the semester for each teacher. They have this printed out and can be used during class to assign a device or initiate an action on the device. If students shift classes during the day, or new students are brought into a class, the roster of bar codes are out of date and a teacher has to reach out to IT to get an updated document.

While conventional technologies allow IT administrators to manually select specific students and generate printable QR codes and/or manual instructions that are meant to be downloaded and distributed, they are often inconvenient and present timing issues that potentially lead to outdated information. This is a manual process that requires a teacher or administrator to reach out to IT in order to get a list of students and corresponding QR codes. This list is printed and given to the teacher or administrator. For every subsequent change where a student switches classes, or schools, or teachers, another request must be made to IT.

The description provided in the background section should not be assumed to be prior art merely because it is mentioned in or associated with the background section. The background section may include information that describes one or more aspects of the subject technology.

### SUMMARY

In particular aspects, the present disclosure provides systems and methods that enable a “manager” or “primary” mobile device to perform selected MDM functions with respect to one or more “managed,” “targeted,” or “secondary” mobile devices. For example, in an educational context, the manager device may be a tablet computer or laptop computer operated by an administrator who schedules deployment of disruptive tasks to managed devices that are managed by a mobile device management service.

According to certain aspects of the present disclosure, a computer-implemented method is provided. The computer-implemented method includes displaying a selection of groups of members associated with a manager device. The computer-implemented method includes retrieving, responsive to selection of one group of the groups of members associated with manager device, group objects associated with the one group that is selected. The computer-implemented method includes determining whether the members of the group selected are selected to be unassigned. The computer-implemented method includes displaying, responsive to determining that the members of the group selected are to remain assigned, a list of members of the group selected. The computer-implemented method includes receiving a selection of one member of the list of the group selected. The computer-implemented method includes determining whether the one member selected is assigned. The computer-implemented method includes creating, responsive to determining that the one member selected is unassigned, a unique identifier associated the group objects and the one member selected. The computer-implemented method includes displaying the unique identifier. The computer-implemented method includes assigning, responsive to a managed device scanning the unique identifier and based on confirmation to assign, the one member selected to the managed device.

According to other aspects of the present disclosure, a system is provided. The system includes a memory comprising instructions and a processor configured to execute the instructions which, when executed, cause the processor to display a selection of groups of members associated with a manager device. The processor is configured to execute the instructions which, when executed, cause the processor to retrieve, responsive to selection of one group of the groups of members associated with manager device, group objects associated with the one group that is selected. The processor is configured to execute the instructions which, when executed, cause the processor to determine whether the members of the group selected are selected to be unassigned. The processor is configured to execute the instructions which, when executed, cause the processor to display, responsive to determining that the members of the group selected are to remain assigned, a list of members of the group selected. The processor is configured to execute the instructions which, when executed, cause the processor to receive a selection of one member of the list of the group selected. The processor is configured to execute the instructions which, when executed, cause the processor to determine whether the one member selected is assigned. The processor is configured to execute the instructions which, when executed, cause the processor to create, responsive to determining that the one member selected is unassigned, a unique identifier associated the group objects and the one member selected. The processor is configured to execute the instructions which, when executed, cause the processor to display the unique identifier. The processor is configured to execute the instructions which, when executed, cause the processor to assign, responsive to a managed device scanning the unique identifier and based on confirmation to assign, the one member selected to the managed device.

According to other aspects of the present disclosure, a computer-implemented method is provided. The computer-implemented method includes querying, responsive to a selection of a settings button on a technician device, groups associated with a location. The computer-implemented method includes retrieving, responsive to selection of one group of the groups of members associated with manager device, group objects associated with the one group that is selected. The computer-implemented method includes determining whether the members of the group selected are selected to be unassigned. The computer-implemented method includes displaying, responsive to determining that the members of the group selected are to remain assigned, a list of members of the group selected. The computer-implemented method includes receiving a selection of one member of the list of the group selected. The computer-implemented method includes determining whether the one member selected is assigned. The computer-implemented method includes creating, responsive to determining that the one member selected is unassigned, a unique identifier associated the group objects and the one member selected. The computer-implemented method includes displaying the unique identifier. The computer-implemented method includes assigning, responsive to a managed device scanning the unique identifier and based on confirmation to assign, the one member selected to the managed device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. It should be noted that although various aspects may be described herein with reference to healthcare, retail, educational, or corporate settings, these are examples only and are not to be considered limiting. The teachings of the present disclosure may be applied to any mobile device environments, including but not limited to home environments, healthcare environments, retail environments, educational environments, corporate environments, and other appropriate environments. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for assigning unique identifiers.

FIG. 2 is a block diagram illustrating the example manager device, at least one managed device, mobile management service, and push notification service from the architecture of FIG. 1 according to certain aspects of the disclosure.

FIG. 3 illustrates an example process for assigning a unique identifier using the example manager device, first managed device, technician device, mobile device management service, push notification service, and, in certain aspects, remote display panel of FIG. 2.

FIG. 4 illustrates another example process for assigning a unique identifier using the example manager device, first managed device, technician device, mobile device management service, push notification service, and, in certain aspects, remote display panel of FIG. 2.

FIG. 5 illustrates an example process for assigning a unique identifier using the example manager device, first managed device, technician device, mobile device management service, push notification service, and, in certain aspects, remote display panel of FIG. 2.

FIG. 6 is block diagram illustrating an example computer system with which the manager device, the at least one managed device, the technician device, the mobile device management service, the push notification service, and the remote display panel of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

Within various industry organizations, such as in education, for example, there are IT administrators who are tasked with making a student roster of bar codes at the beginning of the semester for each teacher. The student roster can be printed out and can be used during class to assign a device or initiate an action on the device. If students shift classes during the day, however, or new students are brought into a class, the printed student roster of bar codes will be out of date and a teacher will have to reach out to IT to get an updated student roster. For such conventional approaches, every subsequent change where a student switches classes, or schools, or teachers, requires another request to IT to generate an updated student roster with corresponding printable unique identifiers.

The disclosed technology provides benefits over the conventional techniques in that all the actions required to obtain current roster information and create a scannable QR code, bar code or unique ID are done on a device that a teacher or administrator already has access to. There is no need to print out anything or to reach out to IT to gather information and generate unique identifier codes. From there, the information that is gathered on a teacher or administrator device is the most up to date information whenever they need it. Meaning, if a student switches classes, an employee is reassigned to a different building or retail store, or the teacher moves to a different class each period/every hour, the most up to date roster is gathered in real time and presented to the teacher or administrator to proceed with their assigning. All of this can be done, in contrast to past approaches, without reaching out to IT to gather a nearly instantaneously out of date printout of a roster.

For example, the disclosed technology solves such problems by allowing the teacher to automatically capture the up-to-date device and student roster, on the fly, and generate the codes of who are in the appropriate assigned class. Having on the fly user/device assignment provides various crucial workflows such as, but not limited to, user-/device-specific app deployment, user-/device-specific settings deployment, user-/device-specific device record adjustment and updates, quality of life/work enhancements (e.g., eliminating IT intervention), and other appropriate workflows.

By leveraging data associated with the known teacher who is assigned to a device, for example, the class and roster data associated with the known teacher that already exists in the mobile device management (MDM) service can be used to present a dropdown of current classes associated with the known teacher. Once the teacher chooses their class from the dropdown, the teacher can then choose an individual student, which automatically generates a unique identifier, such as a QR code, specific to that student on the device of the teacher. The student can then, via his student device, quickly scan that unique identifier, which is either displayed directly on the device of the teacher or displayed on a display panel located in the classroom via the teacher device streaming or transmitting the unique identifier to it. The student could scan the unique identifier displayed on the display panel directly from his classroom seat. In certain aspects, the disclosed technology also allows an IT technician (e.g., via a “technician mode”) to view on an administrator device all teachers to allow for assistance of a particular teacher, if necessary. In such aspects, the “technician mode” and a “teacher mode” can be enabled via usage of a managed app configuration that is set in a managed application. In the “technician mode,” an IT technician, for example, can access students or objects by using methods by accessing information from, but not limited to, all the school district classes, classes in a specific building, classes assigned to a specific teacher, classes of a specific grade, retail store lists of sales district, sales region, or other appropriate geographic location like county or state, and any other appropriate access lists or information.

As an example, in the educational environment, it is a common process when schools start up in the fall, especially in the earlier grade levels (ex K-2), that devices aren't deployed on the first day of school. The school will likely wait a few weeks into the school year to hand out devices, which presents a possible challenge for IT staff as they would typically need to account for this additional work during an already busy startup of school. In addition, these younger grade levels can be challenged by trying to get students to type in their username and password. IT doesn't necessarily want to limit security by creating easier usernames/passwords, but still wants to ensure the right known user is assigned to the right device. By using the disclosed technology, IT could conceivably pre-enroll manage devices over the summer, with just the assignment app installed, and drop them off to each building/classroom. When each building/teacher is ready, they could then go through the assignment app workflow and assign each device to a particular student, at which point, the management application/module knows the owner of the device and can automatically start pushing out apps/settings immediately to the managed devices.

While the disclosed technology is described in educational and retail environments, it should be understood that the teachings of the present disclosure may be applied to any mobile device environments, including but not limited to organization environments, home environments, healthcare environments, retail environments, educational environments, corporate environments, and other appropriate environments. For example, in a retail environment, a set of shared devices can be allocated for a retail location or groups of retail locations. Employees can check out and check in a device by assigning and unassigning it to their name. As another example in a library/inventoried asset organization context, an asset can be checked-out and checked-in using the disclosed technology. Yet another example in a shift-worker/contractor context, an organizational device can be checked-in/checked-out when a worker/contractor is on contract or deployed in the field such that the organizational device can be returned to the organization's storage or headquarters. As yet another example, the disclosed technology can be utilized during an emergency/medical response in a healthcare environment such that the person using a device can be identified or the device can be checked-out to a user during a time of need.

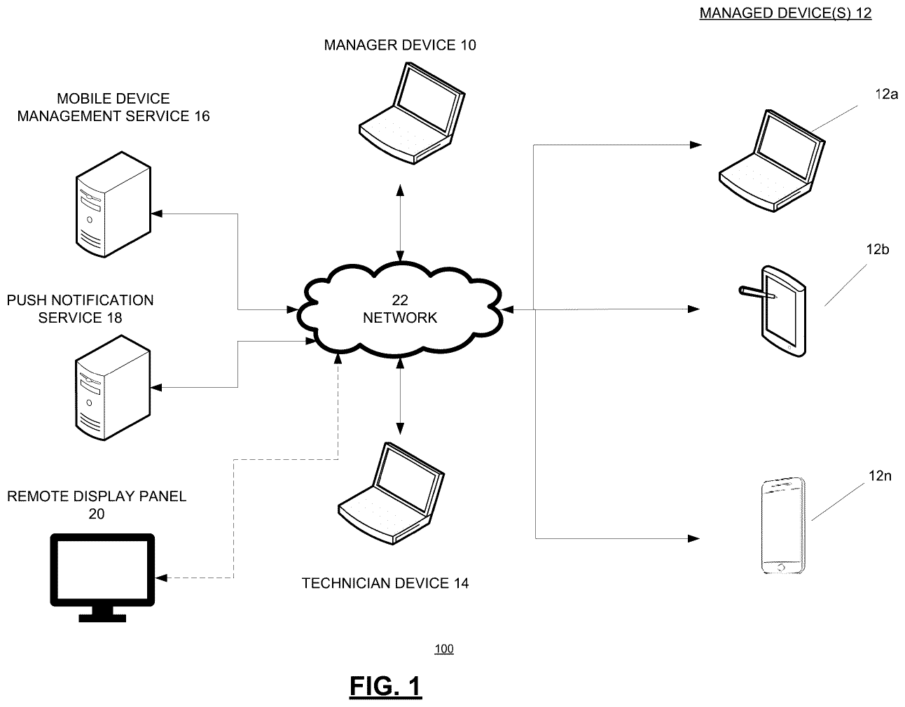

FIG. 1 illustrates an example architecture 100 for assigning unique identifiers. For example, the architecture 100 includes a manager device 10, at least one managed device 12, such as a first managed device 12a and a second managed device 12b to an nth managed device 12n, a technician device 14, a mobile device management service 16, a push notification service 18, and, in some aspects, a remote display panel 20 all connected over a network 22. In certain aspects, the mobile device management service 16 may be connected to the push notification service 18 over a separate network.

The mobile device management service 16 can be any device having an appropriate processor, memory, and communications capability for communicating with the manager device 10, the at least one managed device 12, such as the first managed device 12a and the second managed device 12b to the nth managed device 12n, the technician device 14, and the push notification service 18. For purposes of load balancing, the mobile device management service 16 may include multiple servers. The push notification service 18 can be any device having an appropriate processor, memory, and communications capability for communicating with the mobile device management service 16 and the at least one managed device 12. In certain aspects, the mobile device management service 16 and the push notification service 18 can be a cloud computing server of an infrastructure-as-a-service (IaaS) and be able to support a platform-as-a-service (PaaS) and software-as-a-service (SaaS) services.

The manager device 10, to which the mobile device management service 16, the at least one managed device 12, and in certain aspects, the remote display panel 20 communicates with over the network 22, can be, for example, a tablet computer, a mobile phone, a mobile computer, a laptop computer, a portable media player, an electronic book (eBook) reader, or any other device having appropriate processor, memory, and communications capabilities. Similarly, the at least one managed device 12, such as the first managed device 12a and the second managed device 12b, to which the mobile device management service 16 communicates with over the network 22 via the push notification service 16, can be, for example, a tablet computer, a mobile phone, a mobile computer, a laptop computer, a portable media player, an electronic book (eBook) reader, or any other device having appropriate processor, memory, and communications capabilities. The technician device 14, to which the mobile device management service 16, the at least one managed device 12, and in certain aspects, the manager device 10 communicates with over the network 22, can be, for example, a tablet computer, a mobile phone, a mobile computer, a laptop computer, a portable media player, an electronic book (eBook) reader, or any other device having appropriate processor, memory, and communications capabilities.

It should be noted that although one manager device 10, two managed devices, such as the first managed device 12a and the second managed device 12b to the nth managed device 12n, and one technician device 14 are shown in FIG. 1, the present disclosure is not limited to any particular configuration or number of devices. In certain aspects, a different number of manager devices, managed devices and/or technician devices may be present.

The network 22 can include, for example, any one or more of a personal area network (PAN), a local area network (LAN), a campus area network (CAN), a metropolitan area network (MAN), a wide area network (WAN), a broadband network (BBN), the Internet, and the like. Further, the network 22 can include, but is not limited to, any one or more of the following network topologies, including a bus network, a star network, a ring network, a mesh network, a star-bus network, tree or hierarchical network, and the like.

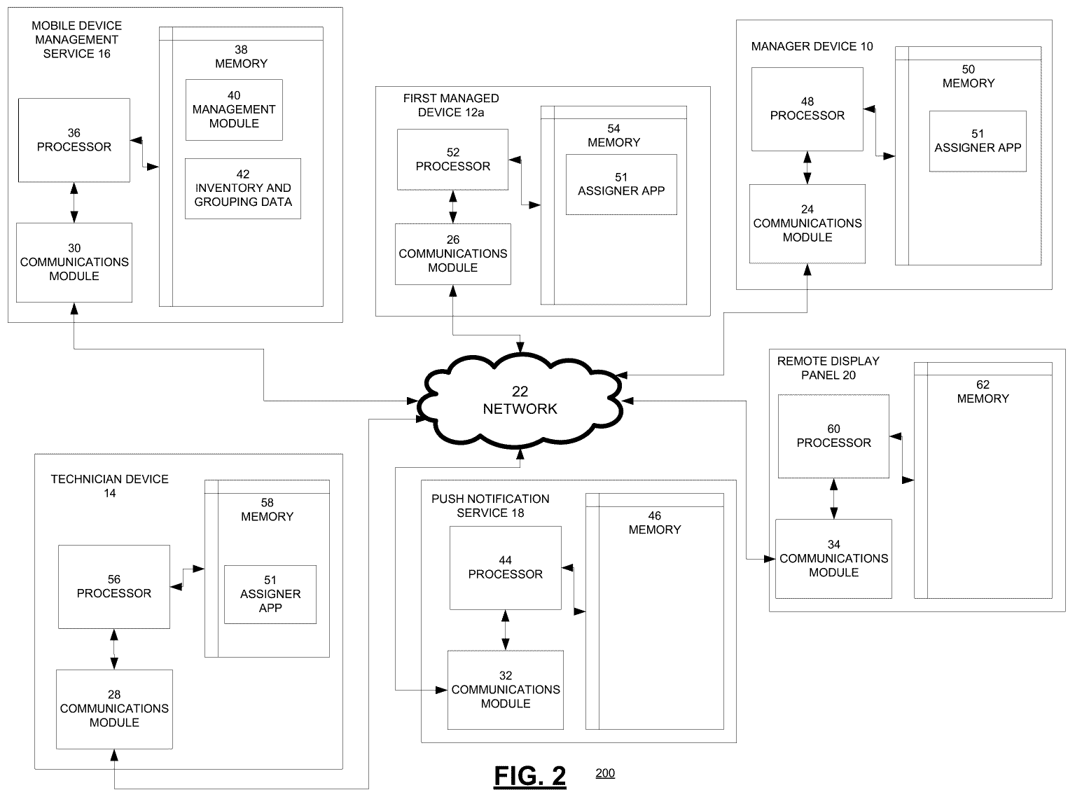

FIG. 2 is a block diagram illustrating examples of the manager device 10, the first managed device 12a, the technician device 14, the mobile device management service 16, the push notification service 18, and, in certain aspects, the remote display panel 20 in the architecture of FIG. 1 according to certain aspects of the disclosure. It should be understood that for purposes of explanation the first managed device 12a is described, but any number of the at least one managed device 12 could be used.

The manager device 10, the first managed device 12a, the technician device 14, the mobile device management service 16, the push notification service 18, and, in certain aspects, the remote display panel 20 are connected over the network 22 via respective communication modules 24, 26, 28, 30, 32, 34. The communication modules 24, 26, 28, 30, 32, 34 are configured to interface with the network 22 to send and receive information, such as data, requests, responses, and commands to devices on the network 22. The communications modules 24, 26, 28, 30, 32, 34 can be, for example, modems or Ethernet cards.

The mobile device management service 16 includes a processor 36, the communications module 30, and a memory 38 that includes a management module 40. The processor 36 of the mobile device management service 16 is configured to execute instructions, such as instructions physically coded into the processor 36, instructions received from software in the memory 38, or a combination of both. The processor 36 of the mobile device management service 16 is configured to determine whether the members of the group selected are selected to be unassigned. The processor 36 of the mobile device management service 16 is configured to determine whether the one member selected is assigned. The processor 36 of the mobile device management service 16 is configured to create, responsive to determining that the one member selected is unassigned, a unique identifier associated the group objects and the one member selected. The processor 36 of the mobile device management service 16 is configured to create, responsive to determining that the one member selected is unassigned, a unique identifier associated the group objects and the one member selected.

The mobile device management service 16 may correspond to hardware and/or software that implement mobile device management functions. For example, the mobile device management service 16 may manage the at least one managed device 12, such as the first managed device 12a. As such, the mobile device management service 16 may store (or access) inventory and grouping data 42 associated with the at least one managed device 12. The inventory and grouping data 42 may include enrollee data identifying all mobile devices that are managed by the mobile device management service 16, as well as data associated with the at least one managed device 12 including the first managed device 12a, and the second managed device 12b to the nth managed device 12n, and grouping information of managed devices within the same designated group.

The push notification service 18 includes a processor 44, the communications module 32, and a memory 46. The processor 44 of the push notification service 18 is configured to execute instructions, such as instructions physically coded into the processor 44, instructions received from software in the memory 46, or a combination of both.

The manager device 10 includes a processor 48, the communications module 24, and a memory 50 that includes an assigner app 51. The processor 48 of the manager device 10 is configured to execute instructions, such as instructions physically coded into the processor 48, instructions received from software in memory 50, or a combination of both. The processor 48 of the manager device 10 is configured to, via the assigner app 51, display a selection of groups of members associated with a manager device. The processor 48 of the manager device 10 is configured to, via the assigner app 51, retrieve, responsive to selection of one group of the groups of members associated with the manager device, group objects associated with the one group that is selected. The processor 48 of the manager device 10 is configured to, via the assigner app 51, display, responsive to the mobile device management service 16 determining that the members of the group selected are to remain assigned, a list of members of the group selected. The processor 48 of the manager device 10 is configured to, via the assigner app 51, receive a selection of one member of the list of the group selected. The processor 48 of the manager device 10 is configured to, via the assigner app 51, display the unique identifier.

The first managed device 12a of the at least one managed device 12 includes a processor 52, the communications module 26, and a memory 54 that includes the assigner app 51. The processor 52 of the first managed device 12a is configured to execute instructions, such as instructions physically coded into the processor 52, instructions received from software in memory 54, or a combination of both.

The technician device 14 includes a processor 56, the communications module 28, and a memory 58 that includes the assigner app 51. The processor 56 of the first managed device 12a is configured to execute instructions, such as instructions physically coded into the processor 56, instructions received from software in memory 58, or a combination of both. The processor 56 of the technician device 14 is configured to query, responsive to a selection of a settings button on the technician device, groups associated with a location.

The remote display panel 20 includes a processor 60, the communications module 34, and a memory 62. The processor 60 of the remote display panel 20 is configured to execute instructions, such as instructions physically coded into the processor 60, instructions received from software in memory 62, or a combination of both. The processor 60 of the remote display panel 20 is configured to receive streams from the manager device 10 to display the unique identifier 68.

It should be noted that although various embodiments may be described herein with reference to healthcare and educational settings, this is for example only and not to be considered limiting. The teachings of the present disclosure may be applied in other mobile device environments, including but not limited to home environments, corporate environments, retail environments, government environments, organization environments, and other well-known environments.

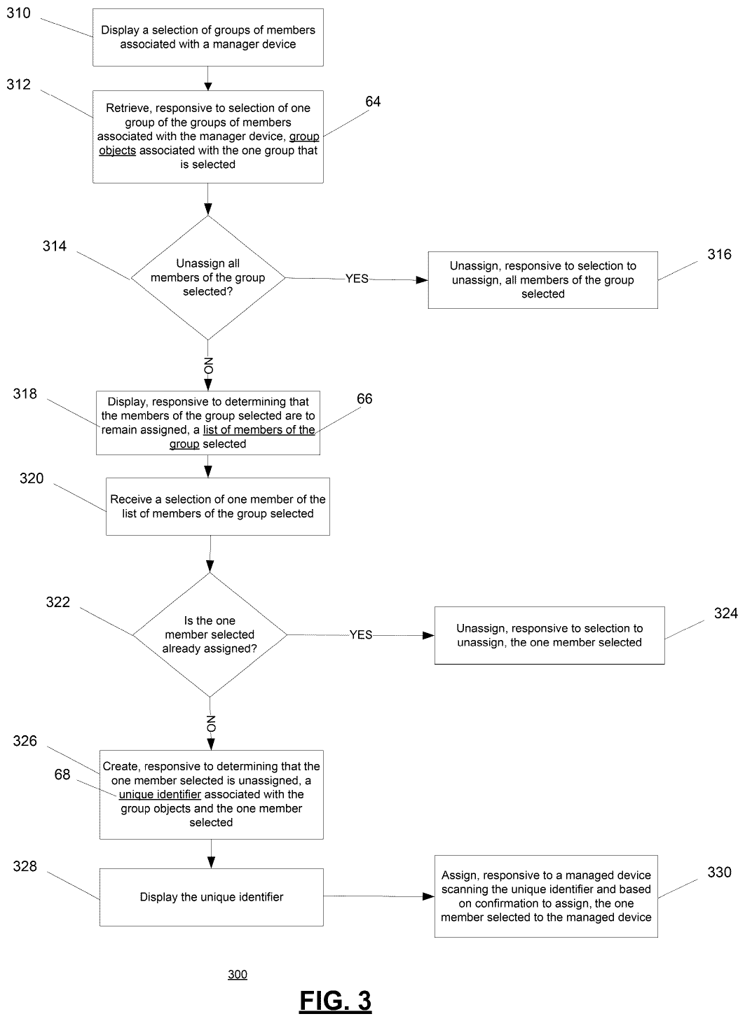

FIG. 3 illustrates an example process 300 using the manager device 10, the first managed device 12a, the technician device 14, the mobile device management service 16, the push notification service 18, and, in certain aspects, the remote display panel 20. While FIG. 3 is described with reference to FIG. 2, it should be understood that the process steps of FIG. 3 may be performed by other systems.

The process 300 begins by proceeding to step 310 when the assigner app 51 via the processor 36 of the mobile device management service 16 displays selection of groups of members from the inventory and grouping data 42 that are associated with the manager device 10. The assigner app 51 is configured to display the selection of the groups of members on the manager device 10. As depicted at step 312, the assigner app 51, responsive to a selection of one group of the groups of members displayed on the manager device 10, retrieves group objects 64, associated with the one group that is selected, from the mobile device management service 16. At decision step 314, the assigner app 51 via the processor 36 of the mobile device management service 16 determines whether a selection has been made by the manager device 10 to unassign all members of the group that is selected. Responsive to an unassign selection being made on the manager device 10, the processor 36 of the mobile device management service 16 unassigns all members of the group that is selected, as depicted at step 316. On the other hand, if the mobile device management service 16 determines that the unassign selection has not been made, the assigner app 51 via the processor 36 of the mobile device management service 16 displays on the manager device 10 a list of members of the group 66 that is selected, as depicted at step 318.

A user of the manager device 10, such as a teacher, a manager, or a supervisor, can select a member of the list of members of the group 66 such that the processor 36 of the mobile device management service 16 via the assigner app 51 receives the selection of the member from the list of members of the group 66, as depicted at step 320. The processor 36 of the mobile device management service 16, as depicted at decision step 322, determines whether the member that is selected has already been assigned. Responsive to an unassign selection being made on the manager device 10, the processor 36 of the mobile device management service 16 unassigns the member who is selected, as depicted at step 324. On the other hand, if the mobile device management service 16 determines that the unassign selection has not been made, the processor 36 of the mobile device management service 16 creates a unique identifier 68 associated with the group objects 64 and the member who is selected from list of members of the group 66, as depicted at step 326.

The assigner app 51 via the processor 36 of the mobile device management service 16, as depicted at step 328, then displays the unique identifier 68. The assigner app 51 is configured to display the unique identifier 68 on the manager device 10. In certain aspects, the assigner app 51 is configured to display the unique identifier 68 on the remote display panel 20. As depicted at step 330, responsive to a managed device, such as the first managed device 12a, scanning the unique identifier 68 (e.g, displayed either on the manager device 10 or the remote display panel 20) and based on confirmation to assign, the mobile device management service 16 assigns the member who is selected to the managed device.

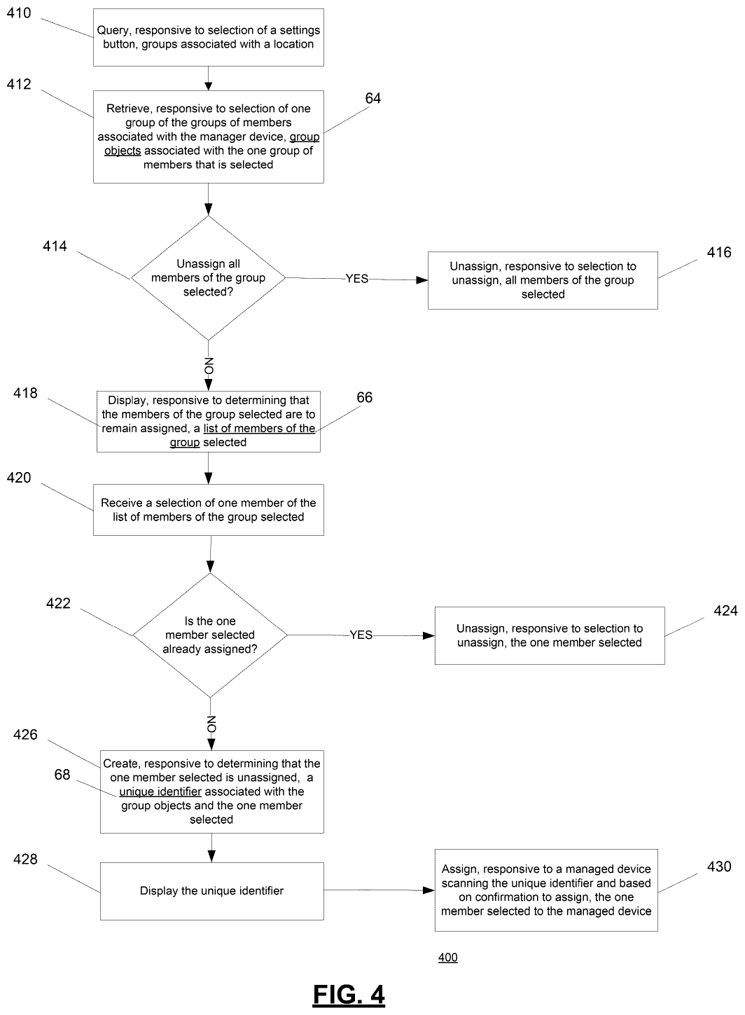

FIG. 4 illustrates another example process 400 using the manager device 10, the first managed device 12a, the technician device 14, the mobile device management service 16, the push notification service 18, and, in certain aspects, the remote display panel 20. While FIG. 4 is described with reference to FIG. 2, it should be understood that the process steps of FIG. 4 may be performed by other systems.

The process 400 begins by proceeding to step 410 when the processor 36 of the mobile device management service 16, responsive to a selection of a settings button displayed on the technician device 14 via the assignment app 51, queries groups associated with a location, such as a specific classroom, for example. As depicted at step 412, the assigner app 51, responsive to a selection of one group of the groups of members displayed on the technician device 14, retrieves group objects 64, associated with the one group of members that is selected, from the mobile device management service 16. At decision step 414, the assigner app 51 via the processor 36 of the mobile device management service 16 determines whether a selection has been made by the technician device 14 to unassign all members of the group that is selected. Responsive to an unassign selection being made on the manager device 10, the processor 36 of the mobile device management service 16 unassigns all members of the group that is selected, as depicted at step 416. On the other hand, if the mobile device management service 16 determines that the unassign selection has not been made, the assigner app 51 via the processor 36 of the mobile device management service 16 displays on the technician device 14 a list of members of the group 66 that is selected, as depicted at step 418.

A user of the technician device 14, such as an IT technician, can select a member of the list of members of the group 66 such that the processor 36 of the mobile device management service 16 via the assigner app 51 receives the selection of the member from the list of members of the group 66, as depicted at step 420. The processor 36 of the mobile device management service 16, as depicted at decision step 422, determines whether the member that is selected has already been assigned. Responsive to an unassign selection being made on the technician device 14, the processor 36 of the mobile device management service 16 unassigns the member who is selected, as depicted at step 424. On the other hand, if the mobile device management service 16 determines that the unassign selection has not been made, the processor 36 of the mobile device management service 16 creates a unique identifier 68 associated with the group objects 64 and the member who is selected from list of members of the group 66, as depicted at step 426.

The assigner app 51 via the processor 36 of the mobile device management service 16, as depicted at step 428, then displays the unique identifier 68. The assigner app 51 is configured to display the unique identifier 68 on the manager device 10. In certain aspects, the assigner app 51 is configured to display the unique identifier 68 on the remote display panel 20. As depicted at step 330, responsive to a managed device, such as the first managed device 12a, scanning the unique identifier 68 (e.g, displayed either on the manager device 10 or the remote display panel 20) and based on confirmation to assign, the mobile device management service 16 assigns the member who is selected to the managed device.

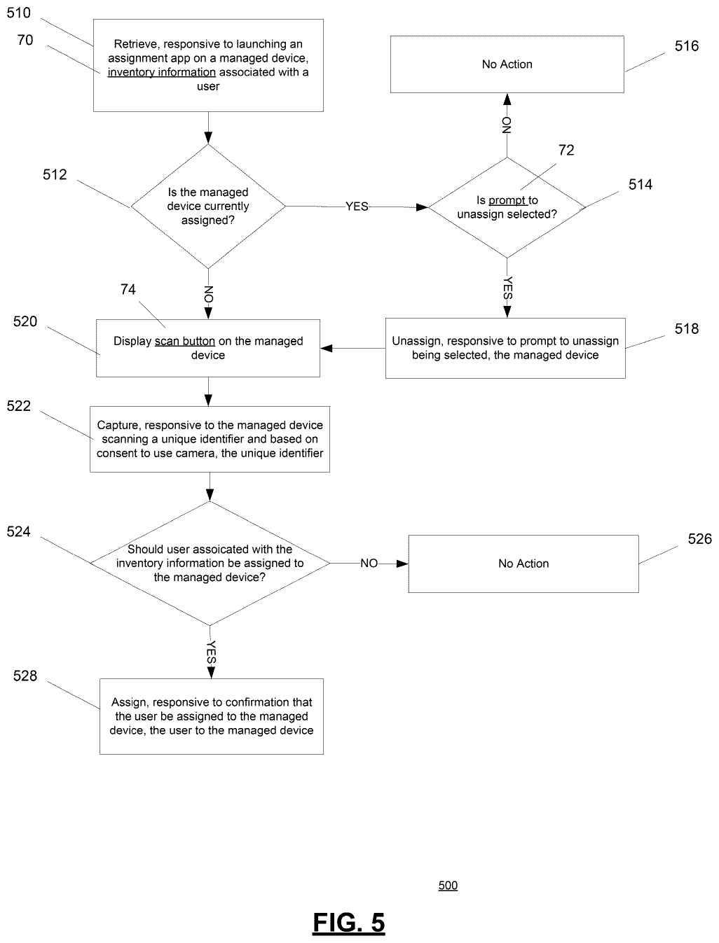

FIG. 5 illustrates another example process 500 using the manager device 10, the first managed device 12a, the technician device 14, the mobile device management service 16, the push notification service 18, and, in certain aspects, the remote display panel 20. While FIG. 5 is described with reference to FIG. 2, it should be understood that the process steps of FIG. 5 may be performed by other systems.

The process 500 begins by proceeding to step 510 when the processor 36 of the mobile device management service 16 retrieves, responsive to an assignment app 51 launching on a managed device 12a, inventory information 70 from inventory and grouping data 42 that are associated with a user, such as a student, for example. The processor 36 of the mobile device management service 16 then determines whether the managed device 12a is currently assigned, as depicted at decision step 512. If the processor 36 of the mobile device management service 16 determines that the managed device 12a is assigned, then the mobile device management service 16, as depicted at decision step 514, determines if a prompt 72 to unassign the managed device 12a, that is displayed on the managed device 12a, has been selected. If the mobile device management service 16 determines that the prompt 72 has not been selected, no action is taken, as depicted at step 516. On the other hand, if the mobile device management service 16 determines that the prompt 72 has been selected, then the mobile device management service 16 unassigns the managed device 12a, as depicted at step 518. The mobile device management service 16 via the assignment app 51 then displays a scan button 74 on the managed device 12a, as depicted at step 520.

Similarly, if the mobile device management service 16 determines at step 512, that the managed device 12a is not currently assigned, the mobile device management service 16 displays the scan button 74 on the managed device 12a, as depicted at step 520. From step 520, the mobile device management service 16 moves to step 522 and captures, responsive to the managed device 12a scanning a unique identifier 68 and based on consent to use a camera of the managed device 12a, the unique identifier 68. The mobile device management service 16 then determines, as depicted at decision step 524, whether the user associated with the inventory information 70 should be assigned to the managed device 12a. If the mobile device management service 16 determines that the user should not be assigned to the managed device 12a, then no action is taken, as depicted at step 526. On the other hand, if the mobile device management service 16 determines that the user should be assigned to the managed device 12a, then the mobile device management service 16 assigns the user to the managed device 12a.

Although certain aspects and workflows are described herein with reference to performing mobile device management for a single managed device, it should be understood that mobile device management may also be performed for multiple devices, such as the first managed device 12a and the second managed device 12b to the nth managed device 12n. In certain aspects, for example, the mobile device management service 16 can be configured, via the management module 40, to allow the manager device 10 to select multiple managed devices or a group of managed devices. A management message may identify multiple managed devices or a group of managed devices of the at least one managed device 12, and the push notification service 18 may send push notifications to each managed device.

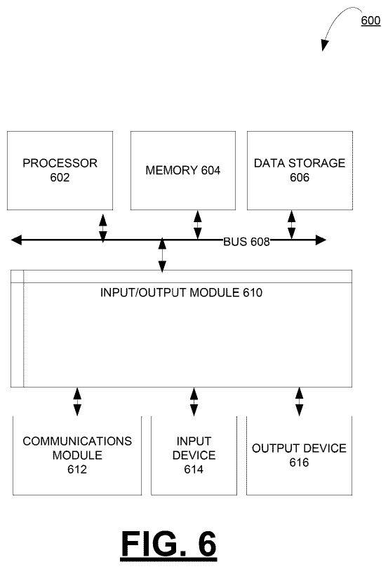

FIG. 6 is a block diagram illustrating an example computer system 600 with which the manager device 10, the at least one managed device 12a, such as the first managed device 12a, the technician device 14, the mobile device management service 16, the push notification service 18, and the remote display panel 20 of FIG. 2 can be implemented. In certain aspects, the computer system 600 may be implemented using hardware or a combination of software and hardware, either in a dedicated server, or integrated into another entity, or distributed across multiple entities.

Computer system 600 (e.g., the manager device 10, the at least one managed device 12a, such as the first managed device 12a, the technician device 14, the mobile device management service 16, the push notification service 18, and the remote display panel 20) includes a bus 608 or other communication mechanism for communicating information, and a processor 602 (e.g., the processor 36, 44, 48, 52, 56, 60) coupled with bus 608 for processing information. According to one aspect, the computer system 600 can be a cloud computing server of an IaaS that is able to support PaaS and SaaS services.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., the memory 38, 46, 50, 54, 58, 60), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer readable medium for execution by, or to control the operation of, the computer system 600.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Example input/output modules 610 include data ports such as USB ports. In addition, input/output module 610 may be provided in communication with processor 602, so as to enable near area communication of computer system 600 with other devices. The input/output module 610 may provide, for example, for wired communication in some implementations, or for wireless communication in other implementations, and multiple interfaces may also be used. The input/output module 610 is configured to connect to a communications module 612. Example communications modules 612 (e.g., the communications module 24, 26, 28, 30, 32, 34) include networking interface cards, such as Ethernet cards and modems.

In certain aspects, the input/output module 610 is configured to connect to a plurality of devices, such as an input device 614 and/or an output device 616. Example input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device.

According to one aspect of the present disclosure the manager device 10, the at least one managed device 12a, such as the first managed device 12a, the technician device 14, the mobile device management service 16, the push notification service 18, and the remote display panel 20 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. Processor 602 may process the executable instructions and/or data structures by remotely accessing the computer program product, for example by downloading the executable instructions and/or data structures from a remote server through communications module 612 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 602 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 608. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
displaying a selection of groups of members associated with a manager device;
retrieving, responsive to selection of one group of the groups of members associated with the manager device, group objects associated with the one group that is selected;
determining whether the members of the group selected are selected to be unassigned;
displaying, responsive to determining that the members of the group selected are to remain assigned, a list of members of the group selected;
receiving a selection of one member of the list of the group selected;
determining whether the one member selected is assigned;
creating, responsive to determining that the one member selected is unassigned, a unique identifier associated the group objects and the one member selected;
displaying the unique identifier; and
assigning, responsive to a managed device scanning the unique identifier and based on confirmation to assign, the one member selected to the managed device.

2. The computer-implemented method of claim 1, wherein the step of displaying the unique identifier further comprises:
displaying the unique identifier on the manager device.

3. The computer-implemented method of claim 1, wherein the step of displaying the unique identifier further comprises:
displaying the unique identifier on a remote display panel.

4. The computer-implemented method of claim 1, further comprising:
unassigning, responsive to determining that the members of the group selected are to be unassigned, all members of the group selected.

5. The computer-implemented method claim 1, further comprising:
unassigning, responsive to determining selection to unassign has been selected, the one member selected.

6. The computer-implemented method claim 1, wherein the list of members of the group selected are students.

7. The computer-implemented method of claim 1, wherein the unique identifier is one of a bar code, a QR code, and a unique code.

8. A system comprising:
a memory comprising instructions; and
a processor configured to execute the instructions which, when executed, cause the processor to:
display a selection of groups of members associated with a manager device;
retrieve, responsive to selection of one group of the groups of members associated with the manager device, group objects associated with the one group that is selected;
determine whether the members of the group selected are selected to be unassigned;
display, responsive to determining that the members of the group selected are to remain assigned, a list of members of the group selected;
receive a selection of one member of the list of the group selected;
determine whether the one member selected is assigned;
create, responsive to determining that the one member selected is unassigned, a unique identifier associated the group objects and the one member selected;
display the unique identifier; and
assign, responsive to a managed device scanning the unique identifier and based on confirmation to assign, the one member selected to the managed device.

9. The system of claim 8, wherein the instructions to cause the processor to display the unique identifier further comprises instructions to cause the processor to:
display the unique identifier on the manager device.

10. The system of claim 8, wherein the instructions to cause the processor to display the unique identifier further comprises instructions to cause the processor to:
display the unique identifier on a remote display panel.

11. The system of claim 8, further comprising instructions to cause the processor to:
unassign, responsive to determining that the members of the group selected are to be unassigned, all members of the group selected.

12. The system of claim 8, further comprising instructions to cause the processor to:
unassign, responsive to determining selection to unassign has been selected, the one member selected.

13. The system of claim 8, wherein the list of members of the group selected are students.

14. The system of claim 8, wherein the unique identifier is one of a bar code, a QR code, and a unique code.

15. A computer-implemented method comprising:
querying, responsive to a selection of a settings button on a technician device, groups associated with a location;
retrieving, responsive to selection of one group of the groups of members associated with the manager device, group objects associated with the one group that is selected;
determining whether the members of the group selected are selected to be unassigned;
displaying, responsive to determining that the members of the group selected are to remain assigned, a list of members of the group selected;
receiving a selection of one member of the list of the group selected;
determining whether the one member selected is assigned;
creating, responsive to determining that the one member selected is unassigned, a unique identifier associated the group objects and the one member selected;
displaying the unique identifier; and
assigning, responsive to a managed device scanning the unique identifier and based on confirmation to assign, the one member selected to the managed device.

16. The computer-implemented method of claim 15, wherein the step of displaying the unique identifier further comprises:
displaying the unique identifier on the manager device.

17. The computer-implemented method of claim 15, wherein the step of displaying the unique identifier further comprises:
displaying the unique identifier on a remote display panel.

18. The computer-implemented method of claim 15, further comprising:
unassigning, responsive to determining that the members of the group selected are to be unassigned, all members of the group selected.

19. The computer-implemented method of claim 15, further comprising:
unassigning, responsive to determining selection to unassign has been selected, the one member selected.

20. The computer-implemented method of claim 15 wherein the unique identifier is one of a bar code, a QR code, and a unique code.
